(19) United States
(12) Patent Application Publication
(10) Pub. No.: US 2020/0229349 A1
(43) Pub. Date: Jul. 23, 2020

(54) Corn Sheller

(71) Applicant: David Grotegut, Gruver, TX (US)

(72) Inventor: David Grotegut, Gruver, TX (US)

(21) Appl. No.: 16/555,678

(22) Filed: Aug. 29, 2019

Related U.S. Application Data
(60) Provisional application No. 62/793,993, filed on Jan. 18, 2019.

(51) Int. Cl. A01F 11/06; B02B 3/08; A01F 12/44

(52) U.S. Cl. CPC A01F 11/06; A01F 12/446; B02B 3/08

(57) ABSTRACT

A system and method for a sheller. The sheller has a receiver coupled to a pan. The receiver is hollow and coupled to a cap. A conveyor extends from a downstream end of the receiver. Spent cobs exit the receiver via the conveyor. The system further includes a plunger sized to be received by the receiver. The plunger is used to force ears of corn into the receiver.

### PRIORITY

This application claims priority to U.S. 62/793,993 filed Jan. 18, 2019, the entirety of which is hereby incorporated by reference.

### BACKGROUND OF THE INVENTION

### Technical Field

The present invention relates to a system and method for a corn sheller.

### Description of Related Art

Shelling corn involves removing the corn from the cob. Traditionally, this is a very tedious and labor intensive practice. Consequently, there is a need for a faster system and method for shelling corn.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a sheller in one embodiment;

FIG. 2 is a perspective view of a sheller in use in one embodiment;

FIG. 3 is a cross-sectional view of a receiver in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

As noted, shelling corn, such as a sweet corn, is often a highly labor intensive exercise. The system and method discussed herein offers an efficient and fast way to shell corn. While one embodiment will be described in reference to sweet corn, this is for illustrative purposes only. As one example, certain shellers can be used with maize. The system and method discussed herein can be used to shell virtually any type of corn.

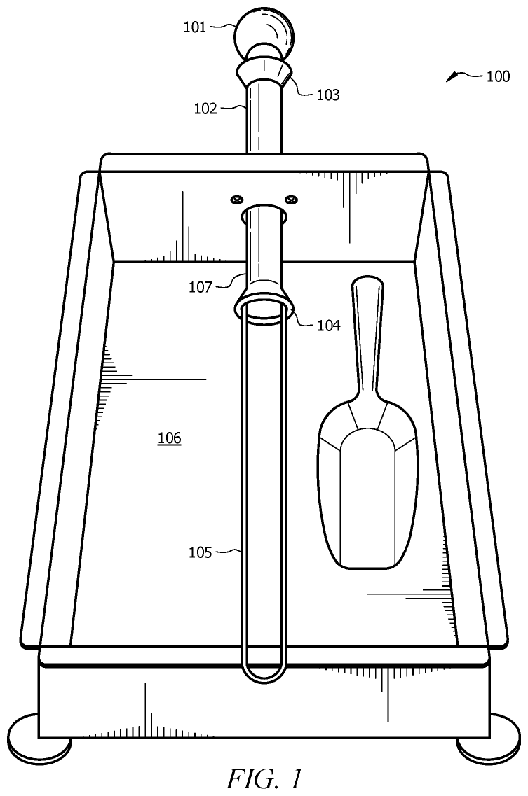

Turning to FIG. 1, FIG. 1 is a perspective view of a sheller in one embodiment. As shown the sheller 100 comprises a pan 106 for housing the shelled corn. The pan 106 can comprise virtually any material known in the art. In one embodiment the pan 106 comprises a food grade material. The size and volume of the pan 106 can be adjusted depending upon the specific operation. In one embodiment, and as depicted, the pan 106 comprises a finite volume. As shown, the pan 106 comprises a bottom and four sides, a left side, a right side, a front side, and a rear side, which each extend upward relative to the bottom. The top of the pan 106 is open to allow the user to retrieve the shelled corn kernels, as discussed in more detail below.

In one embodiment, coupled to the pan 106 is the receiver 102. As depicted the receiver 102 is coupled to a front wall, and the conveyor 105, discussed in more detail below, is coupled to a rear wall. In one embodiment the front wall has a greater height than the rear wall. In one embodiment the receiver 102 is fixedly coupled to the pan 106 such that the neither move during operation. In one embodiment the receiver 102 can be removed from the pan 106 for cleaning and maintenance, but it remains fixed and immobile during use.

The receiver 102 is a generally hollow and tubular member which receives an ear of corn. The length can vary depending upon the desired size, but in one embodiment the receiver 102 has a length greater than the length of an average ear of corn.

As shown, a portion of the receiver 102 extends to the outside of the pan 106. Thus, in one embodiment, a portion of the receiver 102 extends upstream of the pan 106. As used herein, upstream and downstream refer to relative locations in the process. In FIG. 1, the process begins by inserting an ear of corn into the top open end of the receiver 102. Thus, the top end is upstream of the bottom end. The bottom end of the receiver 102 is downstream of the top end of the receiver 102.

As depicted, the pan comprises a front wall and the receiver 102 extends through the first wall. As such the upstream portion of the receiver 102 is located outside of the pan 106, but a downstream portion of the receiver 102 extends within the void of said pan 106.

In one embodiment the portion of the receiver 102 which extends upstream of the pan 106 comprises a solid exterior surface and does not have any exit holes. An exit hole is a hole which fluidly connects the inside of the receiver to the outside of the receiver.

It should be noted that while one embodiment utilizing a pan 106 is disclosed, this is for illustrative purposes only and should not be deemed limiting. The pan 106 serves several functions, as discussed in more detail below. First, the pan 106 serves as a location to collect the kernels 113 which are shelled from the cob 108. Second, the pan 106 provides a surface upon which the conveyor 105 can affix or support to allow the cob 108 to exit the pan 106. Third, the pan 106 provides a way to support and hold the receiver 102. While the pan 106 can accomplish these goals, in other embodiments a pan 106 is not needed. Instead, the user may grasp the receiver 102 with one hand and force the ear of corn through the receiver 102 with the other hand. In such a scenario, where the receiver 102 is not coupled to a pan 106, the user must hold and position the receiver 102 because the pan 106 is not present to do so. Thus, the user may shell the corn over a bowl, cup, or other container to collect and house the kernels 113. Or, the user may shell the corn directly over a plate of food similar to how cheese is grated directly over a plate.

In still other embodiments, the receiver 102 is coupled to a structure. The structure can be a bowl, cup, or pan 106 as depicted. In other embodiments, the structure can simply be a wall which is not attached or affixed to a pan or bowl which has any specified volume. Instead, such a wall is used only to provide support—it is not used to collect any shelled kernels. The structure can also comprise legs or struts such as a bi-pod or tri-pod which hold the receiver 102. In such embodiments the kernels 113 can be exited to and collected by another, and uncoupled, container, bowl, sink, etc.

As depicted, the upstream top end of the receiver 102 comprises a funnel 103. The funnel 103 has a greater diameter than the diameter of the body of the receiver 102. A funnel 103 helps receive the corn and direct it to the central portion of the receiver 102.

Upstream of the funnel 103 is a removable plunger 101. The plunger 101 is moveable relative to the fixed receiver 102. The plunger 101 comprises an outer diameter which is less than the inner diameter of the receiver 102. In this fashion, the plunger 101 can be inserted into the open upstream end of the receiver 102 and move through the hollow receiver 102.

As shown, the plunger 101 comprises a handle to allow for better control and maneuverability. The plunger 101 can comprise virtually any material. In one embodiment the plunger 101 has a greater length than the receiver 102.

The downstream end of the receiver 102 comprises a cap 104. In one embodiment the cap 104 is welded, soldered, bolted, or otherwise coupled to the receiver 102.

The cap 104 has an inner diameter which is less than the inner diameter of the receiver 102. Thus, the cap 104 acts a restrictive plate. The corn cob is generally sized so as to pass through the inner diameter of the cap 104. However, the corn which is attached to the cob is too thick to pass. Accordingly, the corn gets stripped from the cob by the cap 104. The relative diameters of the cap 104 and the inner diameter of the receiver 102 can vary on the type of product being shelled. In one embodiment with sweet corn, the cap 104 has an inner diameter of 1.375 inches, and the receiver 102 has an inner diameter of 2.157 inches.

Downstream of the downstream end of the receiver 102 is the conveyor 105. In one embodiment the conveyor 105 is fixedly attached to both the downstream end of the receiver 102 and the downstream end of the pan 106. A conveyor 105, as used herein, refers to an item which moves the cob out of the pan 106.

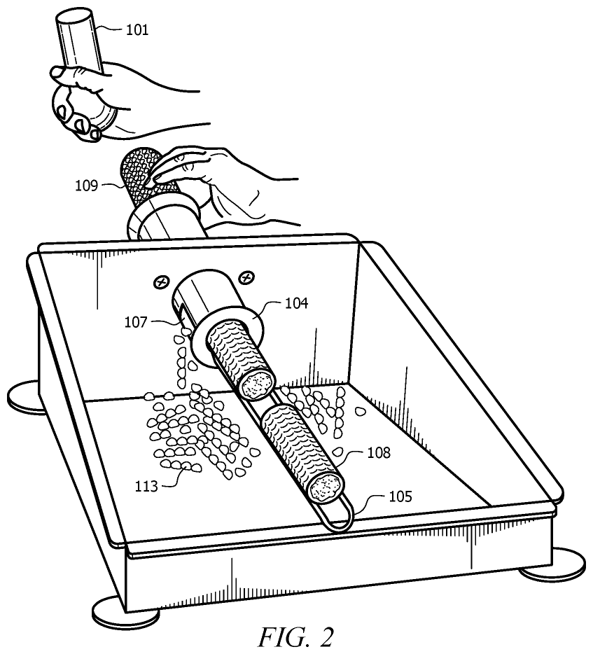

The conveyor 105 can comprise moving parts which transition the cob outside of the pan 106. In other embodiments, however, and as depicted, the conveyor 105 does not comprise any moving parts. As depicted, the conveyor 105 comprises two parallel rods upon which the cobs can ride. The rods support the weight of the corn cob and direct the cobs outside of the pan 106. In one embodiment the upstream end of the conveyor where the conveyor 105 attaches to the receiver 102 is elevated compared to the downstream end of the conveyor 105 which is adjacent to the downstream end of the pan 106. In this fashion, gravity acts upon the corn cob to force the cob to slide downward and out of the pan. In the embodiment depicted in FIG. 2, the front side of the pan 106 is taller than the rear side of the pan 106, which allows for the difference in elevation.

In one embodiment it is desirable to keep the cob separate from the shelled corn kernels which are stored in the pan 106. The conveyor 105, in one embodiment, ensures that the corn cobs are directed out of the pan 106.

It should be noted that while the pan 106 is depicted as having a finite volume with a closed bottom surface, this is for illustrative purposes only and should not be deemed limiting. In other embodiments, for example, the bottom of the pan 106 can open or otherwise directed shelled kernels to another process for subsequent handling. In such embodiments rather than acting as a batch operation, the pan 106 can be used in quasi-continuous, continuous, or semi-batch operations.

FIG. 2 is a perspective view of a sheller in use in one embodiment. In this embodiment shown, the upstream end of the conveyor is elevated relative to the downstream end. As can be seen, the cob cores 108 exit the downstream end of the receive 102 and are received by the conveyor 105. As shown the conveyor 105 rests upon the rear wall so that the cobs 108 are deposited outside of the pan 106.

As mentioned above, a portion of the receiver 102 extends outside of the pan 106, and a portion of the receiver 102 extends into the inside cavity of the pan 106. The portion of the receiver 102 extending into the pan 106 cavity comprises at least one exit hole 107. In one embodiment the exit hole 107 is adjacent to the cutter 110. The exit hole 107 is where shelled corn kernels can exit the receiver 102. The exit hole 107 can comprise discrete holes or they can comprise one or more slits. Regardless, the exit hole 107 provides a path for shelled corn kernels to exit the receiver 102. In operation, the cap 104 strips the corn kernels 113 as the corn is pushed downstream. The cob keep moving downstream, but the stripped corn kernels back up against the cap 104. This back pressure causes the stripped corn kernels 113 to exit through the exit hole 107.

The corn kernels 113, upon exiting the exit hole 107, are received by the pan 106. These corn kernels 113 are shelled and removed from the cob 108. They can be cooked, canned, or otherwise further processed.

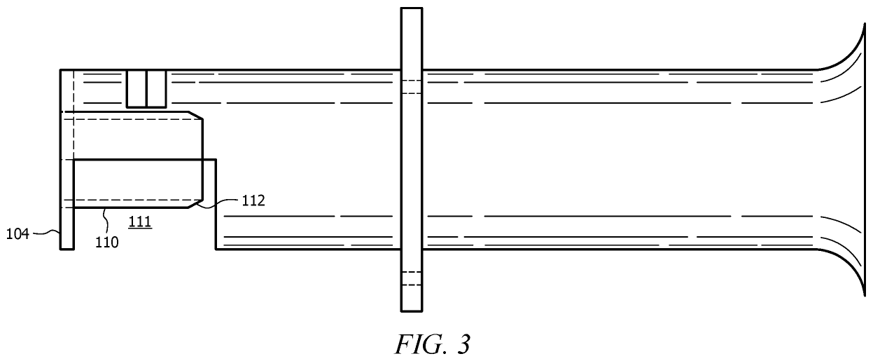

FIG. 3 is a cross-sectional view of a receiver in one embodiment. In this embodiment attached to the cap 104 is the cutter 110. The cutter 110 is recessed into the receiver 102 void. The cutter 110 begins at the cap 104 and extends upstream into the receiver 102.

In one embodiment the cutter 110 has a reduced diameter compared to the receiver. When the corn encounters the cutter 110, the cutter strips the corn off the cob as previously described. In one embodiment the cutter has a reduced upstream diameter of 1.245 inches.

As shown, the cutter 110 has bevels 112 which reduce the opening. This bevel 112 operates to cut and strip the kernels from the cob. As shown, the bevels 112 extend to an upstream diameter of 1.245 inches and end with a downstream diameter of 1.375 inches.

As shown, there is a void 111 upstream of the cap 104. In one embodiment the void 111 is located on the outer perimeter of the receiver 102. In one embodiment this is a hole in the receiver 102. This allows the corn to exit through the receiver 102 as it is being stripped.

As seen in FIG. 2, the user is inserting an ear of corn 109 into the receiver 102. When a force is exerted by the plunger 101 onto the upstream corn 109, the force is transferred to downstream corn located in the receiver 102. The force simultaneously shells the corn and directs the cob out of the receiver.

Now that a system for shelling has been described, a method of shelling corn will now be described. First, at least one, but generally a plurality of ears of corns is obtained and prepared as necessary. Then, when the user is ready to shell the corn, the first ear is inserted into the receiver 102.

Next, a force is applied on the ear of corn to force the corn downstream to where the ear will encounter the cutter 110. Depending upon the length of the receiver 102 and the length of the first ear, the user either uses the plunger 101 or a second ear 109 to apply the force to the first ear, which is now downstream of the second ear. The force causes the first ear to move downstream through the receiver 102 where it encounters the cap 104. At this point, further force separates the kernel 113 from the cob 108. This allows shelled corn kernels 113 to be removed from the cob 108 where they will exit through the exit hole located on the receiver 102. The cob 108 exits the receiver 102 and the shelled corn kernels 113 exits the exit holes 107.

As noted, in one embodiment the cob is directed to exit the pan 106 via the conveyor 105. The shelled corn kernels falls and is collected by the pan 106. The user then uses a third ear and the process is repeated as necessary.

The system and method discussed herein has several benefits. First, the system and method allow for fast and efficient shelling. This was previously a very labor intensive exercise. Now, an ear of corn can be shelled in seconds. The ear of corn can be shelled as fast as the user can shove the corn into the receiver. Often because of the difficulty in shelling, cooks would purchase canned or frozen pre-shelled corn. Now, however, the user can easily obtain freshly shelled corn.

A second benefit is a reduced footprint. While the figures show a large pan for collecting relatively large volumes of kernels, this is for illustrative purposes only and should not be deemed limiting. The receiver and cutter can be used anywhere, including, for example, over a sink or over a bowl. A structure is handy because it allows the user a freehand to guide the corn, but a user can easily hold the receiver in one hand and force the corn into the receiver with the other hand. Thus, a large pan is not necessary. The receiver and cutter can be used, as an example, directly over a dish which requires corn. Thus, the system and method provide a small and portable solution for shelling corn.

A third benefit is that the system and method, in some embodiments, require no moving parts. Moving parts break and wear out. In some embodiments the receiver and cutter and fixed relative to one another: the only thing that moves is the corn. Put differently, the equipment is stationary, and the corn moves relative to the stationary and fixed equipment. In some embodiments, even the conveyor does not comprise any moving parts. Because the system and method does not comprise any moving parts, it is less complicated and less susceptible to breaking and malfunctioning. The system can still be taken apart to clean, sharpen the cutters, etc., but moving parts are not necessary for the operation of the shelling device.

While the invention has been particularly shown and described with reference to a preferred embodiment, it will be understood by those skilled in the art that various changes in form and detail may be made therein without departing from the spirit and scope of the invention.

### ADDITIONAL DESCRIPTION

The following clauses are offered as further description of the disclosed invention.
Clause 1. A system for shelling, said system comprising:
   a receiver having an inner diameter;
   wherein said receiver is hollow and is coupled to a cap;
   wherein said cap is coupled to a cutter which comprises a diameter less than said inner diameter of said receiver;
   wherein said receiver comprises at least one exit hole adjacent to said cutter.
Clause 2. The system of any proceeding or preceding claim wherein said receiver is coupled to a pan, wherein said pain comprises a bottom, four sides, and an open top.
Clause 3. The system of any proceeding or preceding claim wherein said four sides comprises a left side, a right side, a front side, and a rear side, and wherein said front side is taller than said rear side.
Clause 4. The system of any proceeding or preceding claim wherein said receiver is coupled to a structure, and wherein said receiver extends upstream from said pan and a downstream end which extends into said structure.
Clause 5. The system of any proceeding or preceding claim wherein said receiver is coupled to a pan, wherein said pan comprises a front wall, and wherein said receiver extends through said front wall such that an upstream portion of said receiver is out of said pan and a downstream portion of said receiver is within said pan.
Clause 6. The system of any proceeding or preceding claim further comprising a plunger which is sized to fit within said receiver.
Clause 7. The system of any proceeding or preceding claim further comprising a conveyor coupled to said receiver.
Clause 8. The system of any proceeding or preceding claim wherein said receiver is coupled to a structure, wherein said conveyor extends outside of said structure, and wherein said conveyor comprises no moving parts.
Clause 9. The system of any proceeding or preceding claim wherein said cutter begins at said cap and extends upstream within said receiver.
Clause 10. The system of any proceeding or preceding claim wherein said cutter comprises bevels.
Clause 11. The system of any proceeding or preceding claim further comprising a funnel on an upstream end of said receiver.
Clause 12. The system of any proceeding or preceding claim comprising no moving parts.
Clause 13. A method of shelling, said method comprising the steps of:
   a) inserting an ear of corn into a receiver;
   b) applying a force on said ear of corn to force said corn downstream to where the corn encounters a cutter;
   c) allowing shelled corn kernels to exit through an exit hole located on said receiver;
   d) directing said corn cob out of said receiver.
Clause 14. The method of any proceeding or preceding claim wherein said applying a force comprises using a plunger to apply a force against an ear of corn.
Clause 15. The method of any proceeding or preceding claim said receiver is coupled to a pan, and wherein said corn kernels fall into said pan.
Clause 16. The method of any proceeding or preceding claim further comprising a conveyor which directs corn cobs out of said pan.
Clause 17. The method of any proceeding or preceding claim, wherein said pan comprises a bottom, a left side, a right side, a front side, a rear side, and an open top, and wherein said front side is taller than said rear side, and wherein said receiver is coupled to a front side, and wherein said receiver extends upstream from said front side and a downstream end which extends into said pan.
Clause 18. The method of any proceeding or preceding claim wherein said cutter comprises a reduced diameter.

What is claimed is:

1. A system for shelling, said system comprising:
a receiver having an inner diameter;
wherein said receiver is hollow and is coupled to a cap;
wherein said cap is coupled to a cutter which comprises a diameter less than said inner diameter of said receiver;
wherein said receiver comprises at least one exit hole adjacent to said cutter.

2. The system of claim 1 wherein said receiver is coupled to a pan, wherein said pain comprises a bottom, four sides, and an open top.

3. The system of claim 2 wherein said four sides comprises a left side, a right side, a front side, and a rear side, and wherein said front side is taller than said rear side.

4. The system of claim 1 wherein said receiver is coupled to a structure, and wherein said receiver extends upstream from said pan and a downstream end which extends into said structure.

5. The system of claim 1 wherein said receiver is coupled to a pan, wherein said pan comprises a front wall, and wherein said receiver extends through said front wall such that an upstream portion of said receiver is out of said pan and a downstream portion of said receiver is within said pan.

6. The system of claim 1 further comprising a plunger which is sized to fit within said receiver.

7. The system of claim 1 further comprising a conveyor coupled to said receiver.

8. The system of claim 7 wherein said receiver is coupled to a structure, wherein said conveyor extends outside of said structure, and wherein said conveyor comprises no moving parts.

9. The system of claim 1 wherein said cutter begins at said cap and extends upstream within said receiver.

10. The system of claim 1 wherein said cutter comprises bevels.

11. The system of claim 1 further comprising a funnel on an upstream end of said receiver.

12. The system of claim 1 comprising no moving parts.

13. A method of shelling, said method comprising the steps of:
a) inserting an ear of corn into a receiver;
b) applying a force on said ear of corn to force said corn downstream to where the corn encounters a cutter;
c) allowing shelled corn kernels to exit through an exit hole located on said receiver;
d) directing said corn cob out of said receiver.

14. The method of claim 13 wherein said applying a force comprises using a plunger to apply a force against an ear of corn.

15. The method of claim 13 said receiver is coupled to a pan, and wherein said corn kernels fall into said pan.

16. The method of claim 15 further comprising a conveyor which directs corn cobs out of said pan.

17. The method of claim 15, wherein said pan comprises a bottom, a left side, a right side, a front side, a rear side, and an open top, and wherein said front side is taller than said rear side, and wherein said receiver is coupled to a front side, and wherein said receiver extends upstream from said front side and a downstream end which extends into said pan.

18. The method of claim 13 wherein said cutter comprises a reduced diameter.
